(19) United States
(12) Patent Application Publication
(10) Pub. No.: US 2005/0238321 A1
(43) Pub. Date: Oct. 27, 2005

(54) Image editing apparatus, method and program

(75) Inventors: Koichi Gohara, Kanagawa (JP); Hiroshi Murakami, Kanagawa (JP); Kei Yamaji, Kanagawa (JP); Hajime Araya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM., LTD.

(21) Appl. No.: 11/106,689

(22) Filed: Apr. 15, 2005

(30) Foreign Application Priority Data
Apr. 15, 2004 (JP) 2004-120446

(51) Int. Cl. H04N 5/781; G11B 27/00

(52) U.S. Cl. 386/52; 386/125

(57) ABSTRACT

An image editing apparatus reads a selected still image, analyzes an image content, and determines an editing condition. By analyzing the image content, a main subject is determined (concerning whether the main subject is a person or scenery) and a framing (a relative position of the main subjects and the like) is determined. According to the result of analysis, a type of special effect such as zooming or panning and the editing condition such as a zoom point are determined. Further, the image editing apparatus produces a scenario on the basis of the determined editing condition and produces a photo movie. Because the editing condition is determined according to the image content, the photo movie obtains a plot and the quality of the photo movie can be improved. Further, because the image content analysis is automatically performed, operation such as designating the editing condition does not become complicated.

### BACKGROUND OF THE INVENTION

1. Field of the Invention

The present invention relates to an image editing apparatus, an image editing method, and an image editing program for producing a photo movie by editing plural still images.

2. Description of the Related Art

A still image photographed by a digital still camera can be enjoyed by viewing by printing on a photographic paper and by loading image data into a personal computer (PC) and displaying on a monitor by using an image viewer software. In many cases, an image viewer software is provided with a slide show function, which displays still images by changing over the images at a predetermined time interval. By using such function, a user can easily enjoy a large number of still images.

Besides, as a method for viewing still images similar to such slide show, a photo movie is proposed as image sequence which reproduces still images just like a moving picture by using still images as materials and by editing the material (see, for example, U.S. patent application Publication No. 2002/0110354 and “LiFE*with-Photo-Cinema” by digitalstage inc., searched on Apr. 6, 2004, via the Internet, <URL:http://www.digitalstage.net/jp/product/life/index.html>). In a photo movie, motion is provided in still images by providing the still image with a special effect such as a zoom-in processing, which trims a portion of the still image and closes up such portion and panning processing, which moves an eyepoint from one end of the still image to the other.

Such photo movie provides a new way of enjoying the still image different from conventional way of viewing still images, and attracts attention as one of the ways to reuse still images photographed and stored by the user.

U.S. patent application Publication No. 2002/0110354 and “LiFE*with-Photo-Cinema” respectively disclose an image editing software for producing a photo movie using still images as materials. Because both types of such image editing software are intended for use in a personal computer, any user who possesses a personal computer can use such software.

However, in an image editing software as described in U.S. patent application Publication No. 2002/0110354, an editing operation is very complicated because a reproduction order of still images should be designated and special effects should be designated per each still image.

Furthermore, in an image editing software as described in “LiFE*with-Photo-Cinema”, as well as a manual mode, by which a detailed editing designation is made manually, there is provided an automatic mode, which produces a photo movie automatically by merely selecting images used as a material. In such an automatic mode, because all editing conditions, except image selection, are set by automatic setting by a computer, operation becomes very easy. However, in such an automatic mode, a quality of the photo movie often becomes flat because there is no precedence or difference in handling and editing of selected images: that is, for example, an assigned displaying time and the number of times of displaying an image are approximately even.

### SUMMARY OF THE INVENTION

In view of the foregoing, an object of the present invention is to provide an apparatus, a method, and a program capable of producing an impressive high quality photo movie while reducing complication of operation.

In order to achieve the above and the other objects, the present invention produces a photo movie on the basis of an editing condition, by analyzing an image content of plural still images, determining the editing condition in accordance with a result of the analysis.

An image editing apparatus of the present invention includes a reader for reading the still images, an image content analyzing section for analyzing a content of the still image, and an editing condition determining section for determining an editing condition of the photo movie in accordance with a result of the analysis. The image content analyzing section determines whether a main subject of each the still image is a person or not, determines a number of persons in a case where the main subject is a person, and determines a position in a frame region of the main subject. The editing condition determining section determines a zoom point of electronic zooming processing in accordance with the result of analysis. It is preferable that the image editing apparatus further includes a storage section for storing a database for analysis referred to by the image content analyzing section, the database for analysis including image patterns for classifying the main subject. It is preferable that the image editing apparatus further includes a photo movie production section for producing the photo movie on the basis of a scenario produced on the basis of the determined editing condition, and a writer for recording the scenario and the photo movie on a recording medium.

In a method of editing an image and a program for editing an image of the present invention, plural still images are read, a content of the still image is analyzed, and an editing condition of the photo movie is determined in accordance with the result of analysis. It is preferable that in the analysis of the content of the still image, whether a main subject of each the still image is a person or not, a number of persons in a case where the main subject is a person, and a position in a frame region of the main subject are determined. Besides, it is possible to determine a zoom point of electronic zooming processing in accordance with the result of analysis. In addition, it is preferable that the feature of still image data in accordance with the content of a subject is compiled as a database in advance and the analysis of the image content of the still image is performed by referring to the database. Specifically, it is preferable that a relationship between plural image patterns and types of a main subject are compiled as a database and that the main subject is determined by referring to the database after the still images are patterned. It is preferable that the image editing method further includes the steps of producing the photo movie on the basis of a scenario produced on the basis of the determined editing condition and recording the scenario and the photo movie on a recording medium.

In a method of editing an image and a program for editing an image according to another aspect of the present invention, plural still images are read, a content of the still image is analyzed, a scenario suitable to the still image content is extracted from among plural types of scenario stored in advance, in accordance with the result of analysis. Here, the scenario includes an editing condition of the photo movie. In addition, in a case where there is a plurality of the extracted scenario, one scenario selected from among the extracted scenario. Besides, a photo movie is produced on the basis of the selected scenario.

### BRIEF DESCRIPTION OF THE DRAWINGS

The above objects and advantages of the present invention will become apparent to a person skilled in the art from the following detailed description of the preferred embodiments of the invention when read in conjunction with the accompanying drawings, in which:

FIG. 1 is a block diagram showing an image editing apparatus;

FIG. 2 is an explanatory diagram showing a form of storing a photo movie on a medium;

FIG. 3 is an explanatory diagram showing a special effect applied to a photo movie;

FIG. 4 is an explanatory diagram showing a special effect other than shown in FIG. 3;

FIG. 5 is an explanatory diagram showing a scenario file;

FIG. 6 is a flow chart showing one example of processes of analyzing a content of an image and determining an editing condition;

FIG. 7 is a flow chart showing a process of producing a photo movie; and

FIG. 8 is an explanatory diagram showing an example of the case where scenario candidates are displayed so that an operator selects a scenario.

### DETAILED DESCRIPTION OF THE PREFERRED EMBODIMENT(S)

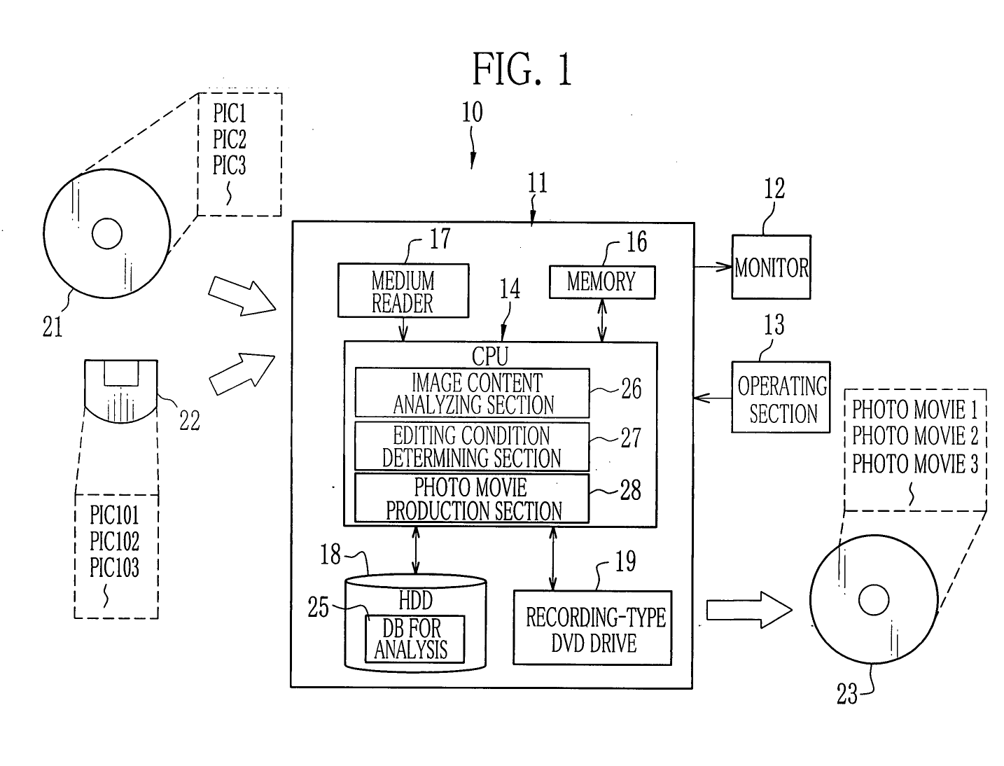

In FIG. 1, the image editing apparatus 10 captures still image data (PIC) stored in, for example, various types of optical recording medium 21 such as a CD and DVD and recording media such as a memory card 22, produces a photo movie or image sequence on the basis of the data, and writes the photo movie into, for example, a DVD medium 23. The image editing apparatus 10 is installed in, for example, a photo shop or a convenience store which provides service for printing photographs or writing digital data on the recording medium, and is operated by a user who brings in photographic data (still image data) or an operator such as a shop clerk.

The image editing apparatus 10 includes a main unit 11, a monitor 12, and an operating section 13. In the main unit 11 an image editing program is installed, with a general purpose personal computer or a workstation, for example, as a base. The main unit 11 includes a CPU 14, a memory 16, a medium reader 17, a hard disk drive (HDD) 18, and a recording-type DVD drive 19. The CPU 14 controls over sections of the apparatus in accordance with an operating system.

The medium reader 17 reads the data from the optical recording medium 21 or the memory card 22. On the monitor 12, an operation screen of an image editing program or a still image which is read is displayed. The operating section 13 is an input device for inputting an operational command into the image editing apparatus 10 and includes a mouse and a keyboard. The recording-type DVD drive 19 is a disk drive or writer for writing the data on the DVD medium 23.

As the DVD medium 23, there are a DVD−R and DVD+R, as a nonrewritable type, and a DVD−RW, DVD+RW, and DVD-RAM, as a rewritable type. Besides, as a data recording format for determining a file format and a data storing format in recording on each of such media, there are formats such as a DVD-VIDEO format, a DVD-VR (Video Recording) format, and the like. Any of such formats can be used, however, in view of the convenience of an orderer or customer, a combination which has the least device dependency on reproduction equipment is ideal.

Thus, the image editing apparatus 10 uses a DVD−R medium and uses a DVD-VIDEO format as the data recording format. Because such combination of formats makes it possible to reproduce on most of products such as a DVD drive built in in a computer or a DVD player, which is considered as one of household electric appliances, a photo movie can be viewed on a television set placed in the living room of a home. Of course, it is not necessary to use a DVD as the recording medium. A next-generation recording medium which is expected to become widespread such as Blu-ray (registered trademark), as well as existing recording media such as a CD medium, may be used. Further, it is possible that the orderer selects from among a plurality of types of the recording medium at the desire of the orderer.

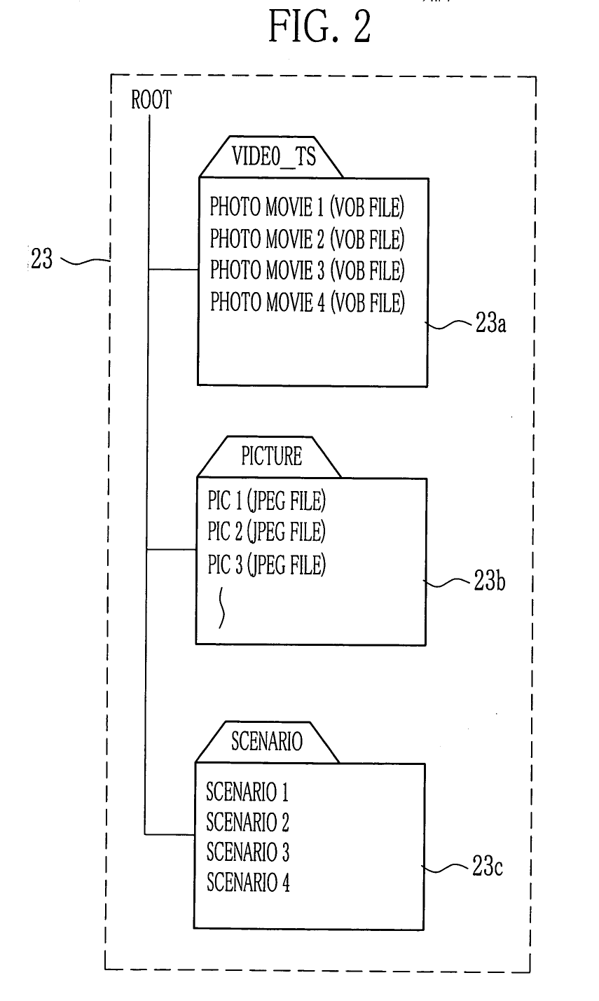

In FIG. 2, in the case of the DVD-VIDEO format, the produced photo movie is stored in the format of a VOB file in a VIDEO_TS folder 23a. A VOB file is a file in which a motion picture file encoded in an MPEG2 format, a common compression format of a motion picture, is converted in accordance with the DVD-VIDEO format.

On the DVD medium 23, the still image data (PIC) used as materials of the photo movie and a scenario file are, as well as the produced photo movie, stored respectively in a picture folder 23b and a scenario folder 23c. The still image data is a file of a JPEG format, which is a file format for compressing and storing data. Of course, the still image data may be of a non-compressed file format. The still image data is usually of a pixel number of 3,000,000 pixels.

The scenario file, as mentioned below, is a description file in which an editing condition is described and recorded in a chronological order. The photo movie is produced in accordance with the editing (graphically modifying, combining, and the like of the image) condition described in the scenario file, however, the produced photo movie file is complete as a motion picture file independent of the scenario file, and the scenario file is not necessary in reproducing the photo movie file. The purpose of recording the scenario file on the DVD medium 23 is not for reproducing the photo movie but for use at a later date by an orderer who viewed the photo movie in printing favorite frames within the photo movie. The pixel number of one frame of a motion picture is rather small for use in printing. The data for printing, for example in the case of L-size printing, is of 2,024×1,536 pixels, and one frame of the photo movie is of 640×480 pixels. If the scenario file is recorded as well as the still image data used as the material, it becomes possible to regenerate as one frame the data for printing of high resolution from the still image data, on the basis of the recorded still image data and the scenario file.

In the HDD 18, the operating system and the image editing program are stored. The CPU 14 loads the image editing program into the memory 16 and performs a processing step described in the program. Thus, the CPU 14 functions as an image content analyzing section 26, an editing condition determining section 27, and a photo movie production section 28, which respectively correspond to an execution section of each processing step.

As described below, an image content analyzing section 26 analyzes an image content of the still image selected as the material. By this analysis, what a main subject of the image is (whether a main subject is a person, scenery, or the like), a framing of the image, whether the image is in good focus, and the like are examined. In the HDD 18, a database (DB) 25 for analysis, which is referred to by the image content analyzing section 26 when an image content analysis is performed, is stored. The DB 25 for analysis is a database in which a feature of the image data in accordance with the content of a subject (whether the subject is a person, scenery, or the like) is recorded as a database. By the DB 25 for analysis, discrimination can be performed not only concerning the main subject but also as to whether a road, a building, the sea, a mountain, or the like is included in the frame region or not. Specifically, the DB 25 for analysis is a database of the relationship between an image pattern and the main subject. A pattern is obtained by extracting a feature of the still image. The image pattern which is the same as or similar to the pattern is extracted from the DB 25 for analysis. A subject type of the main subject is classified from the extracted image pattern. The editing condition determining section 27 determines the editing condition, in accordance with a result of the analysis, by automatically determining a scenario suitable to the result of analysis. The photo movie production section 28 produces the photo movie on the basis of the determined editing condition.

Further, in the HDD 18, various types of adjunct data used in the image editing program are also stored. The adjunct data includes a pattern or decorative image which decorates the still image to be the material by being synthesized with the still image. The decorative image includes a mask image, which covers an unnecessary part of a targeted image, and a template image, in which a fitting frame of the targeted image is determined and which is decorated with an illustration and the like. The decorative image adds color to the frame of the photo movie by decorating a background of the still image to be the material and by adding decoration in one spot.

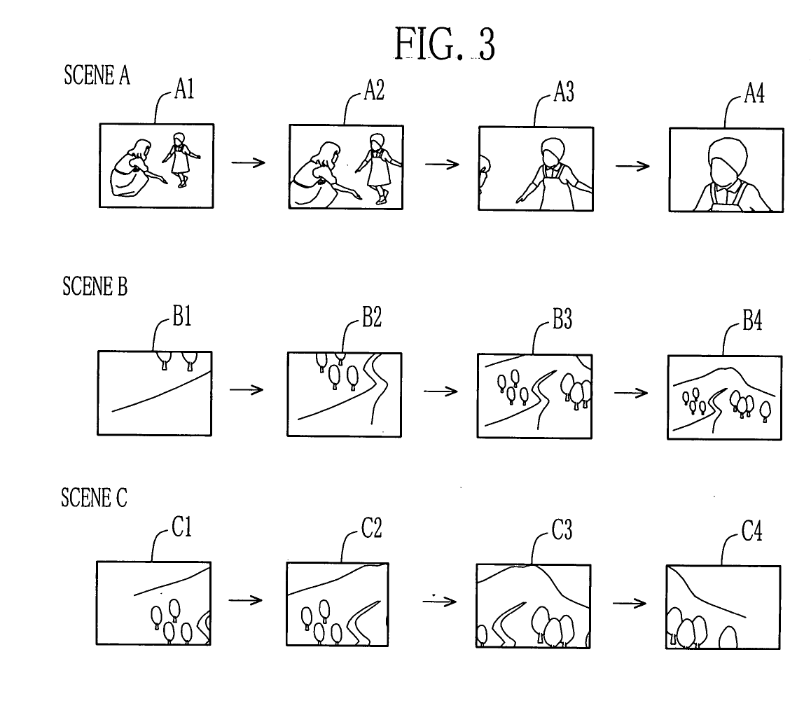

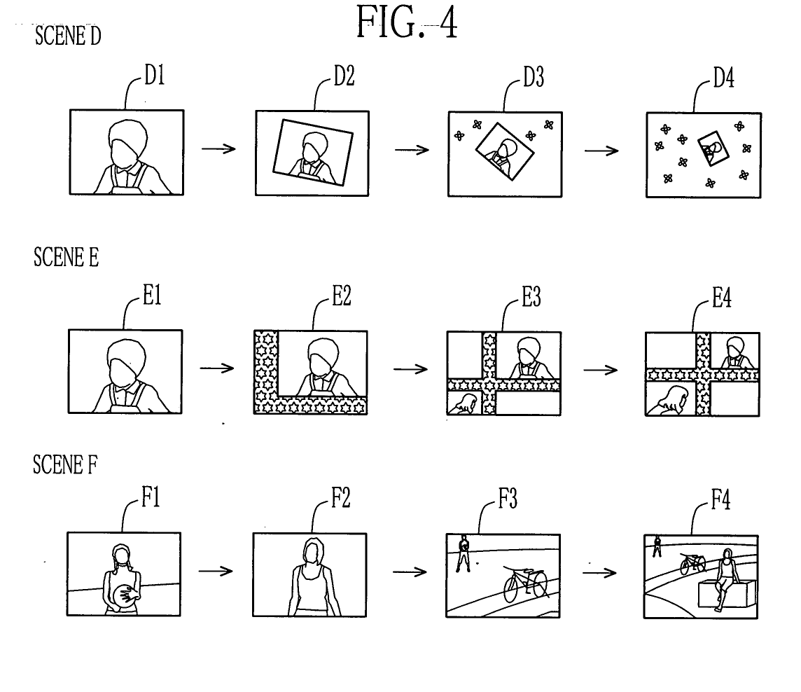

As shown in FIGS. 3 and 4, in producing the photo movie, a special effect such as an electronic zooming processing and a panning processing is provided by modifying the still image to be the material. Scenes A to E are explanatory views showing examples of special effects. The scene A is a scene which begins with a frame A1 of a parent and a child, continues to a frame A2 and a frame A3 which focus on the face of the child and gradually zoom up such part, and ends with a frame A4 which is a close-up of the face of the child. Each frame A1 to A4 constituting the scene A is formed by setting a zoom point at a portion of an original image (still image) corresponding to the frame A1, performing an electronic zooming processing to such portion, and trimming from the original image a partial image of which the magnification is different.

The scene B is a scene which begins with a frame B1 of a surface of a road, then gradually zooms out to end with a frame B4 which shows a mountain lying on the extension of the road in a long-distance view. Also, each frame B1 to B4 constituting the scene B is formed, as in the case of the scene A, by setting a zoom point at a portion of an original image (still image) corresponding to the frame B4, performing an electronic zooming processing to such portion, and trimming from the original image a partial image of which the magnification is different. Because in the scene B, zoom-out is performed from the zoom point, contrary to the scene A in which zoom-in is performed to the zoom point, the zoom magnification of the frame B1, the frame which is inserted first, is the highest, and the zoom magnification of the frame B4, the frame which is inserted last, is the same as the original image.

The scene C is a scene which begins with a frame C1 showing the left foot of a mountain which is the main subject as if a camera were panned horizontally, in order to obtain a panoramic effect, then continues to a frame C2 and a frame C3 showing the mountain positioned in the center of a frame region, and ends with a frame C4 which shows the right foot of the mountain. Each frame C1 to C4 is formed by trimming a part of a still image showing the whole mountain in a long distance view, moving a point from left to right.

The scene D is a scene which begins with a frame D1 showing a close-up of a face of a child and continues to frames D2, D3, and D4 in which the image is reduced and rotated to gradually fade out from the frame region. In the frames D3 and D4, flowers move with shakes or randomly in the background of the image.

In the scene E, a frame E1 showing a child is gradually reduced, with the top-right of the window being a base point, and an image showing a mother is inserted in the screen with being gradually enlarged from the bottom-left of the frame. A boundary of each image is decorated with a cross-shaped band with a star pattern, and the band is inserted from the bottom-left corner of the frame region in accordance with the enlargement of the image showing the mother.

The scene F is a scene in which each frame F1 to F3 is produced by modifying and editing still images corresponding to a frame F4. Still images to be the material show, as shown in the frame F4, a person at a short distance and a person at a long distance. In the scene F, the frame F1 and the frame F2 show a close-up of a person respectively so that the size of each person within the frame region is approximately the same. Then in the subsequent frame F3, the person at a long distance is zoomed out, and the frame F continues to the frame F4, which shows a perspective. By providing such a special effect, a dramatic presentation can be achieved such that the relative position of the two persons cannot be recognized from the frames F1 and F2 inserted first and can be recognized only after frames F3 and F4 are shown.

The photo movie is produced by joining together the scenes thus modified. In this embodiment, for the sake of convenience, explanation is made as if four frames should constitute each scene. However, in fact, there are more frames for one scene. For example, each scene is constituted with a frame rate of about 30 frames per second.

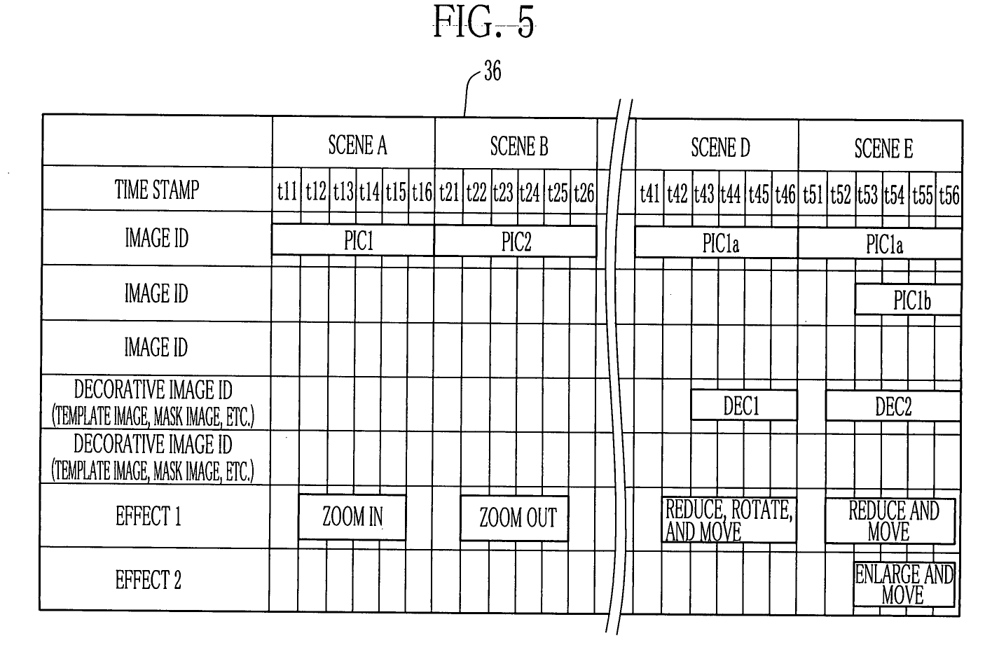

The editing condition of the photo movie is described in a scenario file 36 or description file shown in FIG. 5. In the scenario file 36, the editing condition per each frame is determined and described along with a time axis. The editing condition includes an ID of the image to be used as the material, an ID of the decorative image, type of a special effect, and the like. In the scenario file 36, with the time axis being set on a horizontal axis, what special effect is to be added and which image is designated is determined in accordance with the time stamp of each frame.

For example, as in the case of the scene A, a zoom-in processing is applied all over the scene using an image PIC 1. As in the case of the scene D, using an image PIC 1a obtained by trimming the image PIC 1, a special effect is applied which rotates the image PIC 1a while reducing and moving the same. As in the case of the scene E, at first the image PIC 1a is displayed alone and an image PIC 1b is inserted with a delay. Of course, the scenario file 36 described in this embodiment is merely an example, and there may be various other forms. The scenario file 36 actually includes the detailed data such as the zoom point which indicates the base point of zooming, a zoom magnification, coordinate data which indicates a position of moving, an angle of rotation, and an insertion position of the decorative image.

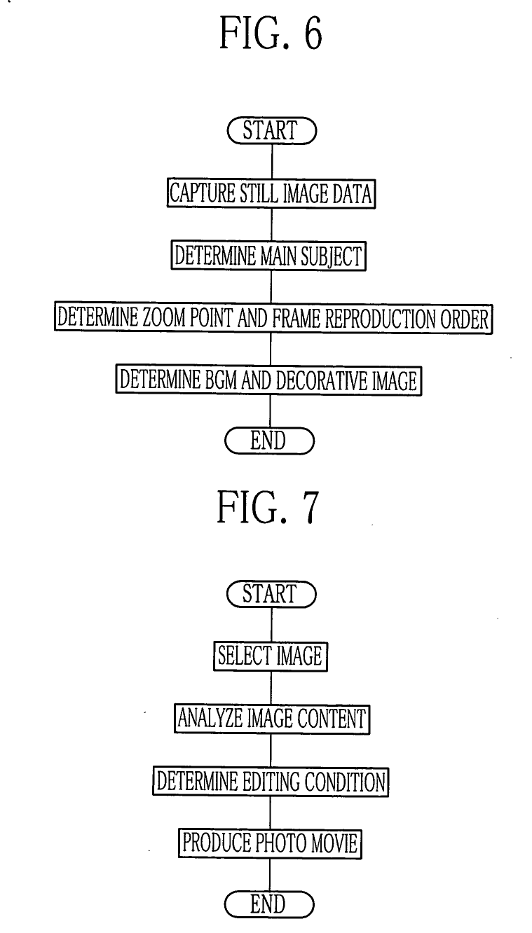

In FIG. 6, the image content analyzing section 26 determines the subject by reading a still image, referring to the DB 25 for analysis, and analyzing the content of the image. The image content analyzing section 26 determines whether the main subject is a person or not. Besides, when the main subject is a person, the image content analyzing section 26 determines whether there are a plurality of main subjects and the like and examines the position of the main subject within the frame region. The editing condition determining section 27 determines, in accordance with the result of the analysis, the editing condition suitable to the result of the analysis and produces the scenario on the basis of the determined editing condition. For example, a reproduction order of the frame is determined so that the zoom point is set at the main subject and the main subject is closed up and then zoomed out, or, on the contrary, that the main subject is zoomed in after the frame overviewing the perspective. In the case where two persons are shown at different distances, as in the case of the frame A4 described above, the scenario as scene F is determined.

Besides, in the case where the main subject is a person, it is possible to construct the photo movie by extracting an image including the person and by mainly setting on the extracted still image. Further, in the case where the image content is determined as a snowy landscape, a decorative image suitable to such landscape (a decorative image in which snow is falling and the like) is automatically selected. In the case of a snowy landscape, BGM (background music) related to winter or snow is automatically selected. Furthermore, in the case where the main subject is an animal, for example a cat or a dog, a decorative image and BGM suitable to such main subject are automatically selected.

Further, by analyzing the framing, in the case, for example, of a photograph showing a mountain in a long distance view of a road, which is used in the above-mentioned scene B and scene C, the zoom point suitable to the framing is determined so that zooming is performed along the road by zooming out, and the like.

The scenario file is produced on the basis of the editing condition thus determined. Then, after a setup such as color tone correction, γ-correction, and posture adjustment of the still image to be the material are performed, a photo movie production processing is performed on the basis of the scenario file. The photo movie production section 28 forms the frame constituting each scene of the photo movie from the still image data of the selected image, in accordance with the scenario file, encodes the formed frame into an MPEG format, and produces one photo movie.

The produced photo movie is written out on the DVD medium 23 in the DVD-VIDEO format via the recording-type DVD drive 19. On the DVD medium 23, the still image data used as the material and the scenario file are recorded as well as the photo movie. In the case where there is a plurality of photo movies, the still image data and the scenario file are recorded in association with each photo movie.

Hereafter, the operation according to the above constitution will be explained referring to the flow chart of FIG. 7. The image editing apparatus 10 sets a recording medium in the medium reader 17 and starts up the image editing program. When the image editing program is started up, a still image selection screen is displayed on the monitor 12 and one or more still image desired by the orderer or customer is selected. After the still image is selected and when production execution is instructed, analysis of the image content of the selected still image is performed and the editing condition is determined in accordance with the result of the analysis. The determined editing condition is stored and compiled in the scenario file or description file, and the photo movie is produced on the basis of the scenario file. The produced photo movie is written out by the recording-type DVD drive 19 as writer and is provided to the orderer.

The photo movie produced in this way is processed in accordance with the image content, that is, the zoom point is set at the main subject, the special effect is determined in accordance with the framing, and the reproduction order of the frame is determined, and the like. Consequently, the photo movie of remarkably high quality can be provided, with the scene being dynamic and a plot becoming clear, compared to a conventional method in which all images should be handled equally in editing.

Further, no complicated operation is necessary because the image content is analyzed and the editing condition is determined in accordance with the result of the analysis.

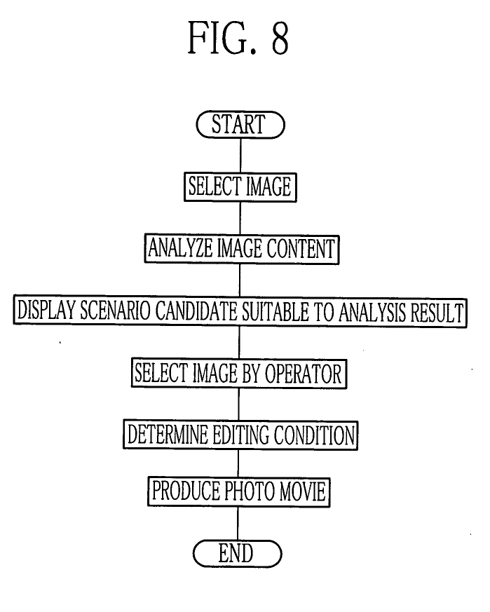

In the above embodiment, explanation is made in an example in which the operator performs operation of still image selection only and the other operations are automatically performed to produce the photo movie. However, as shown in the flow chart of FIG. 8, the scenario may be selected by the operator from among extracted scenario candidates suitable to the result of analysis. In such case, the plural types of scenario files which differ in accordance with the image content is stored in the HDD 18 in advance and the editing condition determining section 27 extracts the scenario file suitable to the image content from among the stored scenario files, in accordance with the result of the analysis. In the case where there are plural extracted scenarios, one scenario among the extracted scenarios is selected by, for example, the operator. By this selection, the scenario (the editing condition) is determined, and the photo movie is produced on the basis of the editing condition. As for the method for displaying the scenario file candidate, it is possible to show the notice or explanation of each scenario or to display a preview of the photo movie to which each scenario is applied to select the scenario file.

In the above embodiment, the scenario file and the still image data, as well as the photo movie, are recorded on the DVD medium provided to the orderer, however, it is possible not to record the scenario file and the still image data and record only the photo movie.

In the above embodiment, the present invention is explained as the embodiment in which the image editing apparatus is installed in a store such as a photo shop, however, in the present invention, the image editing apparatus may be implemented by installation by an individual of the image editing program into his/her PC.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An image editing apparatus for producing a photo movie by editing still images comprising:
a reader for reading plural still images;
an image content analyzing section for analyzing a content of said still images; and
an editing condition determining section for determining an editing condition of said photo movie in accordance with a result of said analysis.

2. An image editing apparatus as claimed in claim 1, wherein said image content analyzing section determines whether a main subject of each said still image is human or not, determines a number of persons in a case where said main subject is human, and determines a position in a frame region of said main subject.

3. An image editing apparatus as claimed in claim 2, wherein said editing condition determining section determines a zoom point of electronic zooming processing in accordance with said result of analysis.

4. An image editing apparatus as claimed in claim 1, further comprising:
a storage section for storing a database for analysis referred to by said image content analyzing section, said database for analysis including image patterns for classifying said main subject.

5. An image editing apparatus as claimed in claim 1, further comprising:
a photo movie production section for producing said photo movie on the basis of a scenario produced on the basis of said determined editing condition.

6. An image editing apparatus as claimed in claim 5, further comprising:
a writer for recording said scenario and said photo movie on a recording medium.

7. An image editing method of producing a photo movie by editing still images comprising the steps of:
reading plural still images;
analyzing a content of said still images; and
determining an editing condition of said photo movie in accordance with a result of said analysis.

8. An image editing method as claimed in claim 7, wherein in said analysis of said content of said still image, whether a main subject of each said still image is human or not, a number of persons in a case where said main subject is human, and a position in a frame region of said main subject, are determined.

9. An image editing method as claimed in claim 7, wherein a zoom point of electronic zooming processing is determined in accordance with said result of analysis.

10. An image editing method as claimed in claim 7, wherein said analysis of said image content of said still image is performed by referring to a database for analysis, said database for analysis including image patterns for classifying said main subject.

11. An image editing method as claimed in claim 7, further comprising the step of:
producing said photo movie on the basis of a scenario produced on the basis of said determined editing condition.

12. An image editing method as claimed in claim 11, further comprising the step of:
recording said scenario and said photo movie on a recording medium.

13. An image editing method of producing a photo movie by editing still images comprising the steps of:
reading plural still images;
analyzing a content of said still images;
extracting at least one scenario suitable to an said image content from among plural types of scenario stored in advance, in accordance with said result of analysis, said scenario including an editing condition of said photo movie;
selecting one scenario, in a case where there is a plurality of said extracted scenarios, from among said extracted scenarios; and
producing a photo movie on the basis of said selected scenario.

14. An image editing program for performing a function for producing a photo movie by editing still images comprising the steps of:
reading plural still images;
analyzing a content of said still images; and
determining an editing condition of said photo movie in accordance with a result of said analysis.

15. An image editing program as claimed in claim 14, wherein in said analysis of said content of said still image, whether a main subject of each said still image is human or not, a number of persons in a case where said main subject is human, and a position in a frame region of said main subject, are determined.

16. An image editing program as claimed in claim 15, wherein a zoom point of electronic zooming processing is determined in accordance with said result of analysis.

17. An image editing program as claimed in claim 14, wherein said analysis of said image content of said still image is performed by referring to a database for analysis, said database for analysis including image patterns for classifying said main subject.

18. An image editing program as claimed in claim 14, further comprising the step of:
producing said photo movie on the basis of a scenario produced on the basis of said determined editing condition.

19. An image editing program as claimed in claim 14, further comprising the step of:
recording said scenario and said photo movie on a recording medium.

20. An image editing program for producing a photo movie by editing still images comprising the steps of:
reading plural still images;
analyzing a content of said still images;
extracting at least one scenario suitable to an said image content from among plural types of scenario stored in advance, in accordance with said result of analysis, said scenario including an editing condition of said photo movie;
selecting one scenario, in a case where there is a plurality of said extracted scenarios, from among said extracted scenarios; and
producing a photo movie on the basis of said selected scenario.
